(19) United States
(12) Patent Application Publication
(10) Pub. No.: US 2025/0364179 A1
(43) Pub. Date: Nov. 27, 2025

(54) CERAMIC ELECTRONIC COMPONENT AND METHOD OF MANUFACTURING SAME

(71) Applicant: TAIYO YUDEN CO., LTD., Tokyo (JP)

(72) Inventor: Hidetoshi MASUDA, Takasaki-shi (JP)

(21) Appl. No.: 19/293,377

(22) Filed: Aug. 7, 2025

Related U.S. Application Data
(63) Continuation of application No. PCT/JP2024/005361, filed on Feb. 15, 2024.

(30) Foreign Application Priority Data
Mar. 8, 2023 (JP) 2023-035559

(51) Int. Cl. H01G 4/008; H01G 4/12; H01G 4/232; H01G 4/248; H01G 4/30; H01G 13/00

(52) U.S. Cl. CPC H01G 4/008; H01G 4/1227; H01G 4/232; H01G 4/248; H01G 4/306; H01G 13/006

(57) ABSTRACT

A ceramic electronic component according to an embodiment of the present invention includes an element body including a capacitive part in which a plurality of dielectric layers containing a ceramic as a main component and a plurality of internal electrode layers are laminated on each other. All elements of Al or Cr, Fe, and Si are present in the capacitive part, and at least one of these elements is precipitated in the internal electrode layers.

### CROSS-REFERENCE TO RELATED APPLICATIONS

The present application is a continuation application of PCT/JP2024/005361, filed Feb. 15, 2024, which claims priority to Japanese Patent Application No. 2023-035559, filed Mar. 8, 2023, the disclosure of which is incorporated herein by reference in its entirety including any and all particular combinations of the features disclosed therein.

### BACKGROUND

### Field of the Invention

The present invention relates to a ceramic electronic component and a method of manufacturing the same.

### Description of the Related Art

With miniaturization of electronic device, further miniaturization has also been demanded for ceramic electronic components such as multilayer ceramic capacitors mounted on the electronic device.

A multilayer ceramic capacitor is a ceramic electronic component that includes an element body having a capacitive part in which a plurality of dielectric layers containing a ceramic as a main component and a plurality of internal electrode layers are alternately laminated on each other. Examples of a method of miniaturizing such a ceramic electronic component and increasing the capacity thereof include a method of decreasing the thickness of the dielectric layers and increasing the capacitance value for each layer and a method of decreasing the thickness of the dielectric layers and the internal electrode layers to increase the number of laminated layers at a specified thickness.

However, since the multilayer ceramic capacitor is usually prepared by integrally firing the dielectric layer and the internal electrode layer, in a case where the thickness of the internal electrode layer is decreased, fracture is likely to occur due to thermal impact or the like during the firing, and thus continuity of the internal electrode layer may be decreased. It is known that when discontinuous sites are present in the internal electrode layer in the ceramic electronic component such as a multilayer ceramic capacitor, dielectric layer portions adjacent to the discontinuous sites of the internal electrode layers do not contribute to the capacitance because a voltage is not applied to the dielectric layer portions. Further, a decrease in facing area between the positive and negative electrodes also leads to a decrease in the capacity.

Therefore, for the purpose of preventing a decrease in continuity in the internal electrode layer even when the thickness of the internal electrode layer is decreased, a multilayer ceramic capacitor in which an internal electrode layer contains Ni and noble metals (elements) has been suggested (see Japanese Patent Laid-Open Nos. 2007-242599 and 2010-153485). It is considered that since the multilayer ceramic capacitors described in Japanese Patent Laid-Open Nos. 2007-242599 and 2010-153485 include internal electrode layers containing Ni and noble metals (elements), grain growth of Ni during firing is inhibited, and thus discontinuity in the internal electrode layers can be prevented.

In the multilayer ceramic capacitors described in Japanese Patent Laid-Open Nos. 2007-242599 and 2010-153485, all the noble metals contained in the internal electrode layers are extremely expensive, which may lead to an increase in the cost of products. Further, Pt, Pd, and the like are classified as rare metals, and thus there is a concern about depletion of natural resources.

### SUMMARY

The present invention has been made in consideration of the above-described circumstances, and an object thereof is to provide a ceramic electronic component and a method of manufacturing the same, which enable improvement of continuity of an internal electrode layer even when the thickness of the internal electrode layer is decreased.

The present inventors have conducted intensive examination in order to achieve the above-described object. Further, the present inventors have found that in a ceramic electronic component that includes an element body including a capacitive part in which a plurality of dielectric layers containing a ceramic as a main component and a plurality of internal electrode layers are laminated on each other, in a case where all elements of Al or Cr, Fe, and Si are present in the capacitive part, and at least one of these elements is precipitated in the internal electrode layers, a ceramic electronic component including internal electrode layers with improved continuity can be obtained even when the thickness of the internal electrode layers is decreased, and thus completed the present invention.

That is, the present invention includes the following aspects.
[1] A ceramic electronic component including: an element body that includes a capacitive part in which a plurality of dielectric layers containing a ceramic as a main component and a plurality of internal electrode layers are alternately laminated on each other, in which the capacitive part contains Al or Cr, and also Fe and Si, and at least one selected from the group consisting of Al, Cr, Fe, and Si is precipitated in the internal electrode layers.
[2] The ceramic electronic component according to the aspect [1], in which in a case where the capacitive part contains Cr, Fe and Cr are segregated at interfaces between the dielectric layers and the internal electrode layers, and Al or Cr, and also Fe and Si are segregated at dielectric crystal grain boundaries in the dielectric layers.
[3] The ceramic electronic component according to the aspect [1] or [2], in which a total content of Al or Cr in the capacitive part is 0.001 at % or greater and 10 at % or less with respect to a total amount of a main component metal element of the internal electrode layers, Al, Cr, Fe, and Si.
[4] The ceramic electronic component according to any one of the aspects [1] to [3], in which a content of Fe in the capacitive part is 0.001 at % or greater and 10 at % or less with respect to a total amount of a main component metal element of the internal electrode layers, Al, Cr, Fe, and Si.
[5] The ceramic electronic component according to any one of the aspects [1] to [4], in which a content of Si in the capacitive part is 0.001 at % or greater and 10 at % or less with respect to a total amount of a main component metal element of the internal electrode layers, Al, Cr, Fe, and Si.
[6] The ceramic electronic component according to any one of the aspects [1] to [5], in which the plurality of dielectric layers and the plurality of internal electrode layers each have a thickness of 1 μm or less.
[7] The ceramic electronic component according to any one of the aspects [1] to [6], in which the dielectric layers are formed of barium titanate.
[8] The ceramic electronic component according to any one of the aspects [3] to [5], in which the main component metal element is Ni.
[9] A method of manufacturing a ceramic electronic component, including: forming an internal electrode pattern containing a main component metal element of an internal electrode layer, Al or Cr, Fe, and Si on a dielectric green sheet to form a lamination unit; laminating a plurality of the lamination units to form a pre-firing capacitive part; and firing the pre-firing capacitive part to obtain a capacitive part.
[10] The method of manufacturing a ceramic electronic component according to the aspect [9], in which the forming of the internal electrode pattern is performed by a vacuum film formation process.
[11] The method of manufacturing a ceramic electronic component according to the aspect [9], in which the forming of the internal electrode pattern is performed by printing.

According to the present invention, a ceramic electronic component including internal electrode layers with improved continuity can be realized even when the thickness of the internal electrode layers is decreased. Further, since at least one element selected from the group consisting of Al, Cr, Fe, and Si is precipitated in the internal electrode layers, a ceramic electronic component equipped with an internal electrode that is inexpensive, thin, and highly continuous and has excellent process stability can be provided. In addition, the ceramic electronic component of the present invention does not use rare metals, and thus can contribute to the sustainability of natural resources.

### BRIEF DESCRIPTION OF THE DRAWINGS

FIG. 1 is a partial cross-sectional perspective view showing a multilayer ceramic capacitor.

FIG. 2 is a cross-sectional view used to describe the continuity of an internal electrode layer and an interface between a dielectric layer and the internal electrode layer.

FIG. 3 is a graph plotting elemental analysis results of the interface between a dielectric layer and an internal electrode layer of a multilayer ceramic capacitor prepared in Example 1.

FIG. 4 is a graph plotting elemental analysis results of the interface between a dielectric layer and an internal electrode layer of a multilayer ceramic capacitor prepared in Example 5.

FIG. 5 is a step diagram showing an example of a method of manufacturing a multilayer ceramic capacitor.

### DETAILED DESCRIPTION OF EMBODIMENTS

Hereinafter, embodiments of the present invention will be described with reference to the accompanying drawings.

### Multilayer Ceramic Capacitor

A multilayer ceramic capacitor 100 includes an element body 10 including a capacitive part 17 in which a plurality of dielectric layers 11 containing a ceramic as a main component and a plurality of internal electrode layers 12 are alternately laminated on each other, and at least two external electrodes 20a and 20b formed on a surface of the element body 10 in a state of being separated from each other, in which each of the external electrodes 20a and 20b is connected to some of the internal electrode layers 12 extracted from the capacitive part 17. The capacitive part 17 is a region of the element body 10 where the internal electrode layers 12 connected to the external electrodes 20a and 20b face each other by sandwiching the dielectric layers 11 therebetween in a lamination direction, and contributes to the capacitance of the multilayer ceramic capacitor 100.

The outer shape of the element body 10 of the multilayer ceramic capacitor 100 is a roughly rectangular parallelepiped shape, and the element body 10 has upper and lower surfaces facing each other in a height direction, two end surfaces that are in contact with the upper and lower surfaces and face each other in a length direction of the element body 10, and two side surfaces that are in contact with the upper and lower surfaces and face each other in a width direction of the element body 10.

The lamination direction of the plurality of dielectric layers 11 and the plurality of internal electrode layers 12 in the multilayer ceramic capacitor 100 may be a height direction, a length direction, or a width direction of the element body 10 or any other direction.

In the element body 10, the internal electrode layer 12 is disposed as an outermost layer of the capacitive part 17 in the lamination direction, and the internal electrode layer 12 as the outermost layer of the capacitive part 17 is covered with a cover layer 13. The cover layer 13 functions as a protective part for protecting the capacitive part 17 formed of the dielectric layers 11 and the internal electrode layers 12. The cover layer 13 may be disposed on the upper and lower surfaces of the element body 10, which face each other in the height direction, but may be disposed on a surface other than the upper and the lower surfaces depending on the positional relationship between the element body 10 and the capacitive part 17 in the lamination direction. The cover layer 13 may be mainly formed of a ceramic material. The materials of the cover layer 13 and the dielectric layer 11 may be the same as or different from each other.

In the element body 10, a side margin portion 15 is provided on the outside of the capacitive part 17 perpendicularly to the lamination direction of the capacitive part 17. The side margin portion 15 is not extracted to the internal electrode layers 12 and functions as a protective part for protecting the capacitive part 17 formed of the dielectric layers 11 and the internal electrode layers 12. That is, the side margin portion 15 is a region adjacent to the capacitive part 17 when viewed in the lamination direction and outside the capacitive part 17, and is also a region where the internal electrode layers 12 are not extracted. The side margin portion 15 may be present on a side surface side of the element body 10, but may be present on a surface side different from the side surface depending on the positional relationship between the element body 10 and the capacitive part 17 in the lamination direction and the position of a forming surface of the external electrodes 20a and 20b to be formed on the surface of the element body 10, or the side margin portion 15 may be present on both of the side surface and any other surface. The side margin portion 15 may be mainly formed of a ceramic material. The materials of the side margin portion 15 and the dielectric layer 11 may be the same as or different from each other. The side margin portion 15 is a region where the capacitance is not generated.

In the element body 10, an end margin portion 16 is provided on the outside of the capacitive part 17, where the internal electrode layers 12 are extracted to the surface of the element body 10. The end margin portion 16 is a region adjacent to the capacitive part 17 when viewed in the lamination direction and outside the capacitive part 17, and is also a region where the internal electrode layers 12 are not extracted. The end margin portion 16 may be present on an end surface side of the element body 10, but may be present on a surface side different from the end surface depending on the positional relationship between the element body 10 and the capacitive part 17 in the lamination direction and the position of a forming surface of the external electrodes 20a and 20b to be formed on the surface of the element body 10, or the end margin portion 16 may be present on both of the end surface and any other surface. The end margin portion 16 is present in one site when the number of surfaces of the element body 10 to which the internal electrode layers 12 are extracted is one, and is present in two sites when the number of surfaces thereof is two. The end margin portion 16 may be mainly formed of a ceramic material. The materials of the end margin portion 16 and the dielectric layer 11 may be the same as or different from each other. The end margin portion 16 may generate a stray capacitance between the internal electrode layers 12 that have been extracted to the same surface, but is basically considered as a region where the capacitance is not generated.

The plurality of internal electrode layers 12 each are extracted to the end margin portion 16 and each electrically connected to the external electrode 20a provided on the outside of the end margin portion 16. Also, another plurality of internal electrode layers 12 each are extracted to another end margin portion 16 present on the other end surface, and each electrically connected to the external electrode 20b. The internal electrode layers 12 may be extracted to respective end margin portions 16 present on surface sides facing each other in the element body 10, may be extracted to respective end margin portions 16 present on surface sides adjacent to each other in the element body 10, or may be extracted to respective different regions of a same end margin portion 16. The external electrodes 20a and 20b may extend from the respective surfaces of the element body 10, on which the end margin portions 16 to which the internal electrode layers 12 are extracted are present, respectively, to another adjacent surface of the element body 10 as long as the external electrodes 20a and 20b are separated from each other.

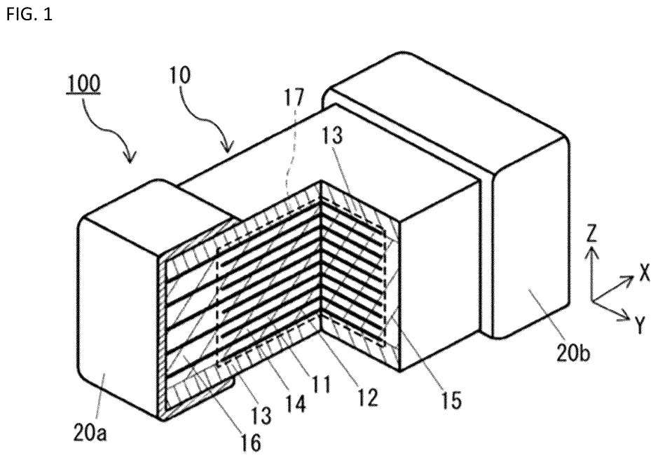

Hereinafter, the ceramic electronic component of the present invention will be described with reference to FIG. 1. Further, FIG. 1 is an example of the multilayer ceramic capacitor 100 which is a ceramic electronic component, and the present invention is not limited to the present aspect.

FIG. 1 is a partial cross-sectional perspective view showing the multilayer ceramic capacitor 100. The multilayer ceramic capacitor 100 includes the element body 10 having a roughly rectangular parallelepiped shape, and the external electrodes 20a and 20b provided on two end surfaces of the element body 10 in a state of being separated from each other. Further, the surfaces of the element body 10 that face each other in the vertical direction (Z-axis direction) are each the upper surface and the lower surface, and the two end surfaces of the element body 10 other than the upper surface and the lower surface are side surfaces.

In the multilayer ceramic capacitor 100 shown in FIG. 1, the external electrodes 20a and 20b provided on the end surfaces extend to the upper surface, the lower surface, and two side surfaces of the element body 10 in the lamination direction. Here, the external electrodes 20a and 20b are separated from each other. Further, in FIG. 1, an X-axis direction (first direction) is the length direction of the element body 10, which is a direction in which the external electrode 20a and the external electrode 20b face each other. A Y-axis direction (second direction) is the width direction of the internal electrode layer 12. The Z-axis direction (third direction) is a lamination direction. The X-axis direction, the Y-axis direction, and the Z-axis direction are orthogonal to each other.

In the multilayer ceramic capacitor 100 shown in FIG. 1, the element body 10 has a configuration in which the dielectric layers 11 containing a ceramic material that functions as a dielectric and the internal electrode layers 12 are alternately laminated on each other, and the plurality of dielectric layers 11 are laminated through the internal electrode layers 12. Some internal electrode layers 12 are extracted to the end margin portion 16, reach the surface of the element body 10 on which the external electrode 20a is provided, and are electrically connected to the external electrode 20a. The other internal electrode layers 12 are extracted to the other end margin portion 16 (not shown), reach the surface of the element body 10 on which the external electrode 20b is provided, and are electrically connected to the external electrode 20b. In this manner, each of the internal electrode layers 12 is electrically conducted with any of the external electrode 20a or the external electrode 20b.

A region where the internal electrode layers 12 connected to the external electrode 20a and the internal electrode layers 12 connected to the external electrode 20b face each other is a region in the multilayer ceramic capacitor 100 where the capacitance is generated, which is a capacity region. This capacity region is shown as a capacity region 14 in the multilayer ceramic capacitor 100 shown in FIG. 1. The capacity region 14 is a region where the adjacent internal electrode layers 12 connected to the external electrode 20a and the external electrode 20b that are different from each other face each other, which is a region corresponding to one of the layers referred to as the dielectric layers 11.

In the element body 10, each of the regions extending from the two side surfaces of the element body 10 to the internal electrode layers 12 is the side margin portion 15. In the multilayer ceramic capacitor 100 shown in FIG. 1, the side margin portion 15 is present on the outer side region of the capacitive part 17, which is the side surface side of the element body 10. As described above, the side margin portion 15 is a region where the capacitance is not generated.

Further, in the multilayer ceramic capacitor 100, the internal electrode layer 12 is disposed as the outermost layer of the capacitive part 17 in the lamination direction (Z-axis direction: third direction), and the upper surface and the lower surface of the capacitive part 17 are covered with the cover layer 13.

The size of the multilayer ceramic capacitor 100 is not particularly limited, and can be appropriately changed depending on the applications thereof. The size of the multilayer ceramic capacitor 100 is, for example, 0.25 mm in length, 0.125 mm in width, and 0.125 mm in height, 0.4 mm in length, 0.2 mm in width, and 0.2 mm in height, 0.6 mm in length, 0.3 mm in width, and 0.3 mm in height, 1.0 mm in length, 0.5 mm in width, and 0.5 mm in height, 3.2 mm in length, 1.6 mm in width, and 1.6 mm in height, or 4.5 mm in length, 3.2 mm in width, and 2.5 mm in height. The size of the multilayer ceramic capacitor 100 may be, for example, length>width≥height, width>length≥height, height>length≥width, or height>width≥length.

Hereinafter, the material and the like of each component constituting the ceramic electronic component 100 of the present disclosure will be described in detail.

### Dielectric Layer

The dielectric layer 11 in the ceramic electronic component 100 of the present disclosure is not particularly limited as long as the dielectric layer 11 contains a ceramic as a main component, and may be appropriately selected depending on the properties required for the ceramic electronic component. Examples of the dielectric layer 11 include a dielectric layer containing, as a main component, a ceramic material having a perovskite structure represented by General Formula ABO₃. Further, the perovskite structure includes ABO_{3-α} deviated from the stoichiometric composition. Here, “α” in the formula denotes deviation from the stoichiometry. Hereinafter, α will be omitted in the formula.

Examples of the ceramic material having a perovskite structure represented by General Formula ABO₃, which forms the dielectric layer 11, include BaTiO₃ (barium titanate), CaZrO₃ (calcium zirconate), CaTiO₃ (calcium titanate), SrTiO₃ (strontium titanate), and Ba_{1-x-y}CaₓSr_{y}Ti_{1-z}Zr_{z}O₃ forming the perovskite structure (0≤x≤1, 0≤y≤1, and 0≤z≤1). Among these, it is preferable that the dielectric layer 11 contains barium titanate (BaTiO₃) as a main component.

The thickness of each dielectric layer 11 is not particularly limited, and is, for example, 0.05 μm or greater and 5 μm or less, 0.1 μm or greater and 3 μm or less, or 0.2 μm or greater and 1 μm or less.

### Internal Electrode Layer

The internal electrode layer 12 in the ceramic electronic component of the present disclosure contains metals as main components. It is preferable that the metals contained in the internal electrode layer 12 include nickel (Ni) as a main component element. Here, the term “main component element” in the present specification denotes an element in which the content thereof is the highest in terms of the atomic percentage (at %). In a case where the metals contained in the internal electrode layer 12 include nickel as a main component element, an increase in the amount of expensive materials such as noble metals to be used is inhibited, and the production cost of the multilayer ceramic capacitor 100 can be reduced.

The internal electrode layer 12 contains, as sub-elements, at least one selected from the group consisting of Al, Cr, Fe, and Si. When the internal electrode layer 12 contains sub-elements, generation of an oxide of the main component metal element alone is avoided, and an oxide obtained by mixing the main component metal element and the sub-elements is generated. In this manner, diffusion of the main component metal element into the dielectric layer 11 is inhibited, and thus the continuity of the internal electrode layer 12 can be improved.

The thickness of each internal electrode layer 12 is not particularly limited, and is, for example, 0.01 μm or greater and 5 μm or less, 0.05 μm or greater and 3 μm or less, or 0.1 μm or greater and 1 μm or less.

Particularly, since the ceramic electronic component of the present disclosure is formed such that the continuity of the internal electrode layer 12 is improved even in a case where the thickness of the internal electrode layer 12 is decreased, the effects of the present invention can be sufficiently exhibited when each of the plurality of internal electrode layers 12 has a thickness of 1 μm or less.

The number of the internal electrode layers 12 laminated is, for example, 10 to 5000, 50 to 4000, or 100 to 3000.

### External Electrode

The materials of the external electrodes 20a and 20b in the ceramic electronic component of the present disclosure are not limited as long as the materials have conductivity. Examples of the materials of the external electrodes 20a and 20b include metals such as copper (Cu), nickel (Ni), tin (Sn), palladium (Pd), platinum (Pt), silver (Ag), and gold (Au), and alloys containing any of these as a main component element.

The external electrodes 20a and 20b may have a plurality of layers or may be provided with a plating layer on the surface thereof. Examples of the plating layer include a Ni plating layer, an Sn plating layer, and a Cu plating layer, and the plating layer may be a laminate body obtained by laminating a plurality of plating layers.

### Cover Layer and Side Margin Portion

The materials of the cover layer 13 and the side margin portion 15 in the ceramic electronic component 100 of the present disclosure are not limited as long as the materials have high electrical insulating properties and low permeability of degradation factors such as moisture. From the viewpoints of uniform contraction during firing in a case of manufacturing the element body 10 in the ceramic electronic component 100 and alleviating an internal stress in the ceramic electronic component 100, it is preferable that the materials of the cover layer 13 and the side margin portion 15 be the same as the materials forming the dielectric layers 11.

### Elements Contained in Capacitive Part of Element Body

The element body 10 in the ceramic electronic component 100 of the present disclosure contains Al or Cr, Fe, and Si at the same time. The element body 10 contains these elements, and thus the ceramic electronic component 100 of the present disclosure has the internal electrode layer 12 with improved continuity even when the thickness of the internal electrode layer 12 is decreased.

The continuity of the internal electrode layer 12 is improved because Cr and Fe, or Fe is segregated at the interface between the dielectric layer 11 and the internal electrode layer 12, Al or Cr, Fe, and Si are segregated at the dielectric crystal grain boundaries in the dielectric layer 11 at the same time, and at least one selected from the group consisting of Al, Cr, Fe, and Si is precipitated in the internal electrode layer 12 at the same time.

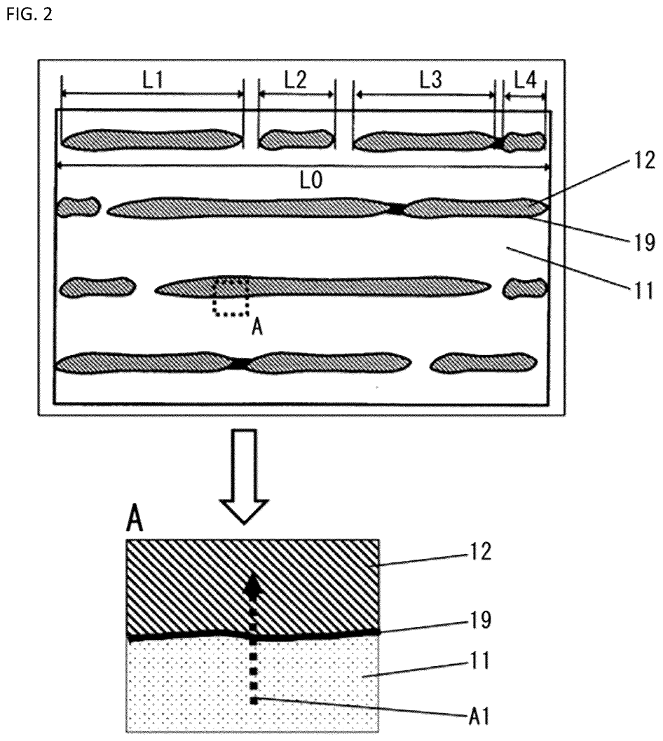

The interface between the dielectric layer 11 and the internal electrode layer 12 and the dielectric crystal grain boundary in the dielectric layer 11 will be described with reference to FIG. 2. FIG. 2 is a cross-sectional view showing a part of the capacitive part 17 of the ceramic electronic component. An interface 19 between the dielectric layer 11 and the internal electrode layer 12 denotes a boundary between the dielectric layer 11 and the internal electrode layer 12 as shown in FIG. 2. Further, the dielectric crystal grain boundary in the dielectric layer 11 denotes the boundary between crystal grains (dielectric crystal grains) of the material contained in the dielectric layer 11 and constituting the dielectric layer 11.

### Interface Between Dielectric Layer and Internal Electrode Layer

The capacitive part 17 of the ceramic electronic component of the present disclosure is formed such that Cr and Fe, or Fe is segregated at the interface 19 between the dielectric layer 11 and the internal electrode layer 12. That is, Cr and Fe coexist, or Fe is present alone at the interface between the dielectric layer 11 and the internal electrode layer 12, and thus remarkable effects are exhibited.

The elements present at the interface 19 between the dielectric layer 11 and the internal electrode layer 12 can contribute to improvement of the diffusion barrier performance of the interface 19. In this case, a plurality of the elements are present and compounded so that the physical properties thereof are changed from the physical properties of each of the elements alone and the diffusion barrier performance of the interface 19 can be greatly exhibited. Since Fe is an element that improves the diffusion barrier performance of the interface 19, and Cr and Fe are a combination that further improves the diffusion barrier performance by being compounded, in a case where Fe or Cr and Fe are present in a compounded state at the interface between the dielectric layer 11 and the internal electrode layer 12, diffusion of the metal elements constituting the internal electrode layer 12 into the dielectric layer 11 is prevented, and as a result, fracture of the internal electrode layer 12 is inhibited. In this manner, even in a case where Fe alone is present at the interface 19 between the dielectric layer 11 and the internal electrode layer 12 or Cr and Fe are present in a compounded state at the interface 19 between the dielectric layer 11 and the internal electrode layer 12, the effect of inhibiting fracture of the internal electrode layer 12 can be exhibited, and the continuity of the internal electrode layer 12 can be improved.

### Dielectric Crystal Grain Boundary of Dielectric Layer

Further, the capacitive part 17 of the ceramic electronic component of the present disclosure is formed such that Al or Cr, Fe, and Si are segregated at the dielectric crystal grain boundaries in the dielectric layer 11. That is, since Al, Fe, and Si coexist or Cr, Fe, and Si coexist at the dielectric crystal grain boundaries in the dielectric layer 11, remarkable effects are exhibited due to the interaction between these elements as compared with a case where these elements are present alone.

Specifically, the fracture of the internal electrode layer 12 can be inhibited when the grain growth of dielectric particles during firing can be inhibited, and the temperature range where the effect of inhibiting the grain growth is strongly exhibited varies for each element. The combination of Al, Fe, and Si or the combination of Cr, Fe, and Si can perform firing in a temperature range where the progress of the grain growth is inhibited, and thus can increase the continuity of the internal electrode layer 12. Further, Al, Fe, and Si, or Cr, Fe, and Si are present in the dielectric crystal grain boundaries in the dielectric layer 11 as a ternary complex oxide containing three kinds of elements and thus can increase the insulation of the dielectric crystal grain boundaries as compared with an oxide of each element alone or a binary complex oxide containing two kinds of elements. Therefore, the insulation reliability of the entire dielectric layer 11 can be increased.

### Internal Electrode Layer

Here, the content of each element is required to be appropriately controlled, and the effects are reduced even when the content thereof is extremely large or extremely small. In order to avoid the reduction of the effects, the elements are added in a slightly excessive amount rather than the appropriate amount, and the excess is precipitated and accumulated in the internal electrode layer 12 so that the excess can be used as a buffer. That is, at least one selected from the group consisting of Al, Cr, Fe, and Si is set to be in a state of being precipitated in the internal electrode layer 12. In a case where there are fluctuations in the material system, the treatment conditions, and the like, the excess is absorbed by the buffer when the amount of elements is greater than the appropriate amount, and the shortage is absorbed from the buffer when the amount of elements is less than the appropriate amount. Therefore, the content of the elements can be appropriately maintained.

Further, when the internal electrode layer 12 contains, as the sub-elements, at least one selected from the group consisting of Al, Cr, Fe, and Si, generation of an oxide of the main component metal element alone in the internal electrode layer 12 is avoided, and an oxide in which the main component metal elements and the sub-elements are mixed is generated. In this manner, the diffusion of the main component metal elements into the vicinity of the dielectric crystal grain boundaries in the dielectric layer 11 can be inhibited to increase the proportion of the sub-elements present at the dielectric crystal grain boundaries. As a result, the insulation of the dielectric crystal grain boundaries can be increased, and thus the insulation reliability of the entire dielectric layer 11 can be increased.

In the present disclosure, the kind of element present in the vicinity of the interface between the dielectric layer 11 and the internal electrode layer 12 can be confirmed by the following procedures, for example, in a case of the multilayer ceramic capacitor 100. First, a thin sample having, as a principal surface, a surface parallel to the lamination direction (Z-axis direction: third direction) and a thickness of 50 nm to 100 nm is taken out using a focused ion beam (FIB) device from a position near the central portion of the element body 10 of the multilayer ceramic capacitor 100 in the width direction (Y-axis direction: second direction), that is, a position between ⅓ and ⅔ of the dimensions in the Y-axis direction. Next, the position near the central portion of the thin sample, that is, the position between ⅓ and ⅔ of each dimension in the Z-axis direction and in the X-axis direction is observed using a scanning transmission electron microscope (STEM) equipped with an energy dispersive X-ray spectrometer (EDS), and a visual field where both the dielectric layer 11 and the internal electrode layer 12 are observed is specified. Further, a difference between the dielectric layer 11 and the internal electrode layer 12 is recognized by a difference in contrast (brightness and darkness) in a STEM image such that the dielectric layer 11 is observed to be dark (darkish) and the internal electrode layer 12 is observed to be bright (whitish). Next, line analysis is performed on the vicinity of the boundary between the dielectric layer 11 and the internal electrode layer 12 using an EDS to measure the characteristic X-ray intensity of each metal element in each measurement site. The measurement is performed by setting the acceleration voltage to 200 kV, the electron beam diameter to 1.0 nm, and the measurement time per measurement point to 20 minutes. Further, the measurement is repeatedly performed five or more times for one measurement point, and the obtained average value of the characteristic X-ray intensities of each element is defined as the characteristic X-ray intensity of each element at the measurement point. The line analysis is performed in a direction (direction indicated by A1 in FIG. 2) perpendicular to the boundary from the dielectric layer 11 side to the internal electrode layer 12 side. Next, correction (ZAF correction) is performed by taking into account the atomic number effect, the absorption effect, and the fluorescence excitation effect from the obtained characteristic X-ray intensity of each element to calculate the atomic percentage of each element at each measurement point, and a graph is created by plotting the atomic percentage with respect to the measurement position. The interface 19 between the dielectric layer 11 and the internal electrode layer 12 is determined based on the obtained graph, and the kind of element unevenly distributed at this interface 19 can be confirmed. The measurement is performed in three different visual fields, and the average value thereof is defined as the atomic percentage of each element.

In the present specification, the interface 19 between the dielectric layer 11 and the internal electrode layer 12 is determined as a surface formed by collection of points where the atomic percentage of the elements excluding oxygen constituting the dielectric layer 11 and the atomic percentage of the main metal elements constituting the internal electrode layer 12 are equal to each other. That is, the interface 19 between the dielectric layer 11 and the internal electrode layer 12 includes the points where the atomic percentage of the elements excluding oxygen constituting the dielectric layer 11 and the atomic percentage of the main metal elements constituting the internal electrode layer 12 are equal to each other in the graph described above.

Further, in the present specification, the segregation of elements at the interface 19 between the dielectric layer 11 and the internal electrode layer 12 denotes a state of the presence of peaks in the vicinity of the points at the interface 19 between the dielectric layer 11 and the internal electrode layer 12 in the above-mentioned graph. Here, the peak denotes a level where the height is 1.5 times or greater the height of the average level in the graph. The vicinity of the interface 19 between the dielectric layer 11 and the internal electrode layer 12 may be, for example, a region within a width of about 10 nm inside and outside the interface 19. That is, the segregation of elements at the interface 19 between the dielectric layer 11 and the internal electrode layer 12 denotes the presence of points in the region within a width of 10 nm inside and outside the interface 19 where the content of the elements is 1.5 times or greater the average content level beyond the region within a width of 10 nm inside and outside the interface 19. Further, non-segregation of elements at the interface 19 between the dielectric layer 11 and the internal electrode layer 12 denotes the absence of points in the region within a width of 10 nm inside and outside the interface 19 where the content of the elements is 1.5 times or greater the average content level beyond the region within a width of 10 nm inside and outside the interface 19. The average content level beyond within a width of 10 nm inside and outside the interface 19 is defined as the average content level of elements in regions with a width of 10 nm to 20 nm on both sides of the interface 19.

The kind of elements present in the vicinity of the dielectric crystal grain boundaries in the dielectric layer 11 can be confirmed using a thin sample taken out from the element body 10 using the same method as described above by specifying the visual field where the dielectric crystal grains inside the dielectric layer 11 are observed using the same method as described above.

In the present specification, the dielectric crystal grain boundary in the dielectric layer 11 is defined as a boundary where the dielectric crystal grains and the surrounding grain boundary portions are identified due to a difference in contrast when a cross section of the dielectric layer 11 is viewed using a scanning electron microscope (SEM).

The segregation of elements at the dielectric crystal grain boundaries in the dielectric layer 11 denotes a state of the presence of peaks in the vicinity of the dielectric crystal grain boundaries in the graph described above. Here, the peak denotes a level where the height is 1.5 times or greater the height of the average level in the graph. The vicinity of the dielectric crystal grain boundaries may be, for example, a region within a width of about 10 nm inside and outside the dielectric crystal grain boundaries. That is, the segregation of specific elements at the dielectric crystal grain boundaries forming the dielectric layer 11 denotes the presence of points in the region within a width of 10 nm inside and outside the grain boundaries where the content of the elements is 1.5 times or greater the average content level beyond within a width of 10 nm inside and outside the grain boundaries. The average content level beyond within a width of 10 nm inside and outside the grain boundaries is defined as the average content level of elements in regions with a width of 10 nm to 20 nm on both sides of the grain boundaries.

In order to confirm the elements precipitated in the internal electrode layer 12, for example, first, the cross section at a position near the central portion of the element body 10 of the multilayer ceramic capacitor 100 in the width direction (Y-axis direction: second direction), that is, at a position between ⅓ and ⅔ of dimensions in the Y-axis direction is polished to prepare a sample with an exposed XZ cross section. Next, the prepared sample is observed using a scanning electron microscope (SEM) equipped with an energy dispersive X-ray spectrometer (EDS), and a visual field where both the dielectric layer 11 and the internal electrode layer 12 are observed is specified. Here, the magnification can be appropriately selected depending on the dimensions of the sample and can be set to, for example, 1000 times to 10000 times. Next, area analysis is performed using an EDS, and the characteristic X-ray intensity of each metal element in each measurement site is measured. The measurement is repeatedly performed five or more times for each measurement point, and the obtained average value of the characteristic X-ray intensities of the elements is mapped as the characteristic X-ray intensity of each element at the measurement point. The measurement is performed in three different visual fields, and it is determined that sub-elements are precipitated in the internal electrode layer 12 when the proportion of the main component metal element in the internal electrode layer 12 is relatively low and a region where the sub-elements are present in a dot shape is confirmed in each visual field.

In the present specification, the precipitation of sub-elements in the internal electrode layer 12 denotes a state where the sub-elements are present in a dot shape in the main component metal element of the internal electrode layer 12 in the area analysis of the SEM-EDS analysis described above.

The total content of Al or Cr in the capacitive part 17 where the dielectric layers 11 and the internal electrode layers 12 are laminated on each other in the ceramic electronic component of the present disclosure is preferably 0.001 at % or greater and 10 at % or less with respect to the total amount of the main component metal element of the internal electrode layer 12, Al, Cr, Fe, and Si.

The content of Fe in the capacitive part 17 where the dielectric layers 11 and the internal electrode layers 12 are laminated on each other in the ceramic electronic component of the present disclosure is preferably 0.001 at % or greater and 10 at % or less with respect to the total amount of the main component metal element of the internal electrode layer 12, Al, Cr, Fe, and Si.

The content of Si in the capacitive part 17 where the dielectric layers 11 and the internal electrode layers 12 are laminated on each other in the ceramic electronic component of the present disclosure is preferably 0.001 at % or greater and 10 at % or less with respect to the total amount of the main component metal element of the internal electrode layer 12, Al, Cr, Fe, and Si.

Here, the content of the metal elements in the capacitive part 17 where the dielectric layers 11 and the internal electrode layers 12 are laminated on each other can be determined, for example, by the following procedure 1 or procedure 2 in a case of the multilayer ceramic capacitor 100. In both the procedure 1 and the procedure 2, the measurement is performed on three or more points, and the average value thereof is defined as the content. In a case where the results obtained by the procedure 1 and the procedure 2 do not match each other and any doubt arises, the content is determined based on the measured value obtained by the procedure 1.

Procedure 1: First, a cross section, which is orthogonal to the direction (X-axis direction: first direction) in which the external electrodes 20a and 20b face each other, where the internal electrode layer 12 is observed is exposed by a method of performing cutting, polishing, or the like on the capacitive part 17 where the dielectric layers 11 and the internal electrode layers 12 are laminated on each other in the element body 10 of the multilayer ceramic capacitor 100. This cross section is defined as a cross section (cross section between ⅓ and ⅔ of the dimensions in the width direction) near the central portion of the element body 10 in the width direction (Y-axis direction: second direction). Next, carbon is vapor-deposited onto the exposed cross section to obtain a sample for measurement. Next, area analysis of scanning the cross section of the sample in 1 μm steps is performed in a range of 300×300 μm near the central portion of the cross section of the sample for measurement under the conditions of an observation magnification of 300 times, an acceleration voltage of 7 kV, and an irradiation current of 50 nA using a scanning electron microscope (SEM) equipped with an energy dispersive X-ray spectrometer (EDS) or a wavelength dispersive X-ray spectrometer (WDS), or an electron probe micro analyzer (EPMA), and the total amount of each element is calculated in terms of the atomic percentage.

Procedure 2: A sample for measurement is prepared in the same manner as in the procedure 1, the obtained sample for measurement is analyzed by a laser ablation inductively coupled plasma mass spectrometry (LA-ICP), and the total amount of each element is calculated in terms of the atomic percentage. Next, the content of each element is calculated based on the obtained atomic percentage of each element.

Further, in a case where the metal composition in a paste for an internal electrode used during production is known and the metal elements in the paste are not added to the dielectric layer 11, the above-described procedures are omitted, and the contents of the metal elements may be respectively calculated based on the known composition.

### Method of Manufacturing Ceramic Electronic Component

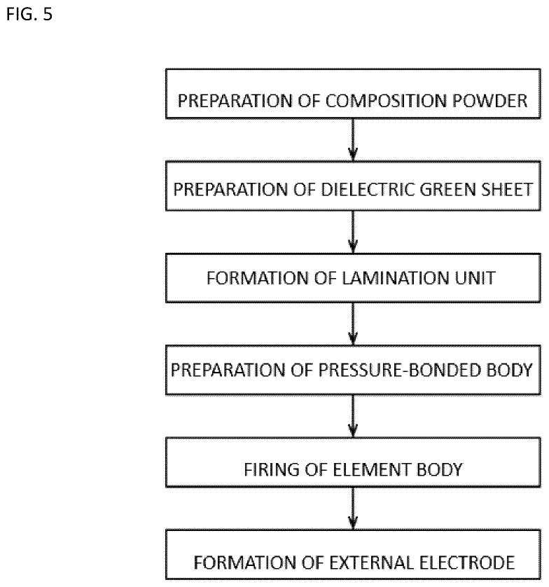

FIG. 5 is a step diagram showing an example of a method of manufacturing the multilayer ceramic capacitor 100. The method of manufacturing the ceramic electronic component of the present disclosure includes forming an internal electrode pattern containing the main component metal element of the internal electrode layer 12, Al or Cr, Fe, and Si on a dielectric green sheet to form a lamination unit, laminating a plurality of lamination units to form pre-firing capacitive part 17, and firing the pre-firing capacitive part 17 to obtain the fired capacitive part 17.

### Preparation of Composition Powder for Dielectric Green Sheet

A composition powder for preparing a dielectric green sheet is obtained by mixing various raw material powders containing constituent elements thereof at a predetermined ratio and performing preliminary calcination (calcination). When the various raw material powders are mixed at a predetermined ratio, various additives such as sintering auxiliary agents may be added thereto, and various additives may further be added to the powder after calcination.

A method of mixing the raw material powders is not particularly limited as long as the powders are uniformly mixed while entrance of impurities is prevented, and any of dry mixing or wet mixing may be adopted. In a case where wet mixing using a ball mill is adopted as the mixing method, for example, the powders are stirred for about 8 hours to 60 hours by a ball mill using partially stabilized zirconia (PSZ) balls and an organic solvent such as ethanol or water as a dispersion medium, and the dispersion medium may be volatilized and dried. As necessary, the particle diameter of the powders may be adjusted by performing a pulverization treatment or performing a combination of a pulverization treatment and a classification treatment.

The conditions for the calcination of the mixed raw material powders are not particularly limited as long as the various raw material powders react with each other to obtain a predetermined composition powder for a dielectric green sheet. As an example, the raw material powders may be fired at a temperature of 800° C. to 1100° C. for 1 hour to 10 hours in the atmosphere. The powder after calcination may be processed into the green sheet as it is, but it is preferable that the powder be pulverized by a ball mill, a stamp mill, or the like from the viewpoint of obtaining a smooth green sheet through a uniform slurry and increasing the sintering property.

Further, in a case where a commercially available product can be used as the composition powder to a dielectric green sheet, the following operations may be performed on this powder without performing the above-described operations of mixing and calcining the raw material powders.

### Preparation of Dielectric Green Sheet

A dielectric green sheet can be prepared by mixing the composition powder for a dielectric green sheet, a binder, and a dispersion medium to prepare a slurry, molding the slurry into a sheet, and drying the sheet.

A binder that can maintain the shape of the dielectric green sheet and volatilizes carbon and the like by performing firing or a binder removal treatment that precedes the firing without allowing the carbon and the like to remain is preferably used as the binder. Examples of the binder that can be used include ones which are polyvinyl alcohol-based, polyvinyl butyral-based, cellulose-based, urethane-based, and vinyl acetate-based. The amount of the binder to be used is not particularly limited, but since the binder is removed in the subsequent step, it is preferable that the amount thereof be minimized within a range where desired moldability and shape retainability can be obtained from the viewpoint of reducing the cost of the raw materials.

A dispersion medium that can be easily removed by volatilization or the like after the molding of the sheet without causing aggregation of the composition powder for a dielectric green sheet and the binder is used as the dispersion medium. Examples of the dispersion medium that can be used include water and an alcohol-based solvent.

Components that adjust the properties of the slurry, such as a dispersant, a plasticizer, and a thickening agent, may be added to the slurry.

A method of mixing the composition powder for a dielectric green sheet with the binder, the dispersion medium, and the like is not particularly limited as long as the components are uniformly mixed while entrance of impurities is prevented. As an example, the components may be mixed by a ball mill.

As a method of molding the prepared slurry into a sheet, for example, a commonly used method such as a die coater method or a doctor blade method can be adopted. A dielectric green sheet can be obtained by drying the prepared sheet-like molded product. Further, a dielectric green sheet laminated on a base material may be obtained, for example, by coating a base material such as a polyethylene terephthalate (PET) film with the prepared slurry and drying the slurry.

### Formation of Lamination Unit by Forming Internal Electrode Pattern

In the method of manufacturing the ceramic electronic component of the present disclosure, a lamination unit is obtained by forming an internal electrode pattern containing the main component metal element of the internal electrode layer 12, Al or Cr, Fe, and Si on the dielectric green sheet obtained above.

A known method can be adopted as a method of forming the internal electrode pattern. For example, the internal electrode pattern may be formed into a film by performing a vacuum film formation process such as sputtering, or the internal electrode pattern may be formed by performing printing.

In a case where the internal electrode pattern is formed into a film by performing a vacuum film formation process such as sputtering, the internal electrode pattern may be formed by using an alloy target containing the main component metal element of the internal electrode layer 12, Al or Cr, Fe, and Si, or simultaneous sputtering may be performed using individual targets.

In a case where the internal electrode pattern is prepared by performing printing, for example, a paste for an internal electrode is prepared, and the paste is printed on the dielectric green sheet.

### Preparation of Paste for Internal Electrode

The paste for an internal electrode, which contains the main component metal element of the internal electrode layer 12, Al or Cr, Fe, and Si, is obtained, for example, by mixing a metal powder containing each metal element with a vehicle using a three-roll mill. The paste for an internal electrode may contain glass frit and the composition powder for a dielectric green sheet in addition to the above-described metals which are essential components.

The type and the amount of the binder and the solvent contained in the vehicle to be used are not particularly limited, and may be appropriately selected in consideration of the viscosity and the handleability of the paste for an internal electrode, the compatibility of the paste with the dielectric green sheet, and the like.

### Printing of Paste for Internal Electrode

The paste for an internal electrode can be printed on the dielectric green sheet, for example, by using a screen mask on which a predetermined internal electrode pattern is formed. An extraction pattern for extracting the internal electrode layer 12 is also printed on the dielectric green sheet. This extraction pattern may be formed simultaneously with or separately from the internal electrode pattern. In a case where the extraction pattern is formed separately from the internal electrode pattern, for example, the extraction pattern may be formed by using a screen mask on which a predetermined extraction pattern is formed. The paste for an internal electrode may be used to form the extraction pattern, and a paste for an extraction portion with a composition different from the composition of the paste for an internal electrode may be separately prepared by the same procedure as that for the paste for an internal electrode and then used.

When the paste for an internal electrode is printed, the paste may be printed on a space that is the side margin portion 15 in a case of forming the element body 10 including the capacitive part 17. Further, in the periphery of the extraction portion, the paste may be printed on a space that is a portion adjacent to the extraction portion in the end margin portion 16. A dielectric paste for forming the side margin portion 15 or the end margin portion 16 may be printed on these spaces. The dielectric paste for forming the side margin portion 15 or the end margin portion 16 may be a paste formed of raw materials that are the same as or different from the raw materials forming the dielectric layer 11. In a case where the raw materials of the dielectric paste for forming the side margin portion 15 or the end margin portion 16 are the same as the raw materials forming the dielectric layer 11, the composition of the dielectric paste may be the same as or different from the composition of the dielectric layer 11.

### Preparation of Pressure-Bonded Body Including Non-Fired Capacitive Part

In the method of manufacturing the ceramic electronic component of the present disclosure, a plurality of the lamination units obtained above are laminated and pressure-bonded to each other to obtain a pressure-bonded body including the non-fired capacitive part 17. Since a pressure-bonded body is prepared by collecting a plurality of the non-fired capacitive parts 17 in a case of using a typical method of manufacturing the multilayer ceramic capacitor 100, a plurality of pre-firing element bodies 10, which include the non-fired capacitive parts 17, are formed by singulating the pressure-bonded body as described below.

The pressure-bonded body is obtained, for example, by laminating a predetermined number of sheets of lamination units on which the internal electrode pattern and the extraction pattern are formed and pressure-bonding the lamination units. The lamination and the pressure-bonding may be performed by a commonly used method, or a method of pressing the lamination units in the lamination direction while heating the laminated lamination units and thermopressure-bonding the lamination units by the action of the binder can be adopted.

Here, in a case where the lamination units on which the internal electrode pattern and the extraction pattern are formed are prepared on a base material, the lamination units are laminated while the base material is peeled off.

In a case of the lamination and the pressure-bonding of the lamination units, a green sheet that becomes a cover portion when the multilayer ceramic capacitor is completed may be added to both end portions in the lamination direction. In this case, the composition of the green sheet to be added may be the same as or different from the composition of the dielectric green sheet on which the internal electrode pattern and the extraction pattern are formed. From the viewpoint of making the contraction ratio uniform during the firing, it is preferable that the composition of the green sheet to be added be the same as or similar to the composition of the dielectric green sheet on which the internal electrode pattern and the extraction pattern are formed.

The pressure-bonded body obtained by pressure-bonding the lamination units is singulated by a commonly used method such as a dicer or a laser cutter, to obtain pre-firing capacitive part 17.

When the pressure-bonded body is singulated, the side margin portion 15 is formed at this stage outside the portion that becomes the capacitive part 17 as viewed in the lamination direction, that is, the portion of the internal electrode layer 12 where the end margin portion 16 including the extraction portion is not formed, to obtain the pre-firing element body 10 which includes the pre-firing capacitive part 17 in a case where a portion that becomes the side margin portion 15 is not formed in advance, that is, in a case where a space that becomes the side margin portion 15 is not provided and a case where printing is not performed to form the side margin portion 15. A method of forming the side margin portion 15 is not particularly limited, and can be appropriately selected from commonly used methods, such as application of a paste for forming the side margin portion 15 and attachment of a sheet. The materials for forming the side margin portion 15 and the composition thereof may be the same as or different from the materials for forming the dielectric layer 11 and the composition thereof.

### Preparation of Element Body (Firing of Pre-Firing Element Body)

In the method of manufacturing the ceramic electronic component of the present disclosure, the element body 10 serving as a molded product including the fired capacitive part 17 is obtained by firing the pre-firing element body 10, which has been singulated as described above. The element body 10 includes the capacitive part 17 in which the dielectric layers 11 and the internal electrode layers 12 are laminated on each other, the end margin portion 16 adjacent to the capacitive part 17 and including the extraction portion extracted from the internal electrode layers 12, the side margin portion 15 adjacent to the capacitive part 17 and including no extraction portion, and the cover layer 13. Prior to the firing, the binder may be removed from a pre-firing molded product. In this case, the removal of the binder and the firing may be continuously performed using the same firing device.

The conditions for removal of the binder and firing may be appropriately set in consideration of the volatilization temperature and the content of the binder, the sintering property of the composition powder for a dielectric green sheet, and the heat resistance and the oxidation resistance of the metals contained in the paste for an internal electrode and the paste for a extraction portion. As an example of the conditions for removing the binder, the binder may be removed at a temperature of 200° C. to 500° C. for 5 hours to 20 hours in a nitrogen (N₂) atmosphere.

The external electrodes 20a and 20b can also be formed on the pre-firing element body 10 of the element body 10. In this case, a conductive paste adheres to an extraction surface of the element body 10 in the middle of the firing, onto which the extraction pattern has been extracted, after removal of the binder from the pre-firing element body 10. Examples of an adhesion method for the conductive paste include printing and dipping. Thereafter, the element body 10 can be obtained at the same time as preparing the external electrodes 20a and 20b in which the conductive paste is sintered, by completing the firing of the element body 10 in the middle of the firing.

As the conditions for firing the element body 10 in a case of including the external electrodes 20a and 20b, for example, the element body 10 may be maintained at 800° C. to 1000° C. for 10 minutes to 1 hour and fired at 1000° C. to 1400° C. for 10 minutes to 2 hours in a reducing atmosphere where nitrogen (N₂), hydrogen (H₂), and water vapor (H₂O) are mixed. The multilayer ceramic capacitor 100 with a large capacitance is obtained by maintaining the temperature in the middle of the firing.

After the firing, a reoxidation treatment may be performed by maintaining the temperature at 600° C. to 1000° C. in a nitrogen (N₂) gas atmosphere or a low-oxygen atmosphere. Further, instead of singulating the pressure-bonded body prior to firing and firing the obtained pre-firing element body 10, the pressure-bonded body may be fired without being singulated, subjected to a reoxidation treatment as necessary, and singulated, thereby obtaining a plurality of element bodies 10.

### Formation of External Electrode

In a case where the external electrodes 20a and 20b are formed on the prepared element body 10, the element body 10 is burned after the conductive paste adheres to the extraction surface of the element body 10. In this manner, the multilayer ceramic capacitor 100 can be obtained by formation of the external electrodes 20a and 20b on the element body 10. Examples of the adhesion method for the conductive paste include printing and dipping. A plating layer and the like may be provided on the surface of the element body 10 in a case of forming the external electrodes 20a and 20b including a plurality of layers. Examples of the plating layer include a Ni plating layer, a Sn plating layer, and a Cu plating layer. The external electrodes 20a and 20b may be a laminate body in which a plurality of plating layers are laminated.

In addition, the present invention is not limited to the above-described embodiments, and various modifications can be made within the scope of the present invention.

For example, in the above-described embodiments, the multilayer ceramic capacitor 100 has been described as an example of the ceramic electronic component according to the present invention, but the ceramic electronic component according to the present invention is not limited to the multilayer ceramic capacitor 100, and as long as an electronic component includes the element body 10 including the capacitive part 17 in which the plurality of dielectric layers 11 and the plurality of internal electrode layers 12 are laminated on each other, the technical scope of the present invention includes the electronic component.

### EXAMPLES

Hereinafter, the present invention will be described in more detail with reference to examples and the like, but the present invention is not limited to these examples.

### Examples 1 to 3 and 5 to 7

### Preparation of Paste for Internal Electrode

A paste for an internal electrode, which contained, as sub-elements, at least one or more metals selected from the group consisting of Al, Cr, Fe, and Si was prepared using Ni as the main component metal element of the internal electrode layer 12. The types and contents of the sub-elements used are listed in Table 1. The contents of the elements in Table 1 are in units of atomic percentage (at %) with respect to the total amount of Ni and blended sub-elements.

The paste for an internal electrode was prepared by mixing Ni, metal powders serving as sub-elements, and a vehicle using a three-roll mill.

### Formation of Internal Electrode Pattern and Extraction Pattern

A dielectric green sheet containing BaTiO₃ powder as the composition powder for a dielectric green sheet was prepared, and the paste for an internal electrode, which had been prepared above, was printed on the surface of the dielectric green sheet to form an internal electrode pattern. An extraction pattern was also printed using the paste for an internal electrode at the same time as the printing of the internal electrode pattern.

### Preparation of Pre-Firing Element Body

Thirteen layers of the dielectric green sheets on which the internal electrode pattern and the extraction pattern were formed were laminated on the cover layer 13 prepared in advance, and the cover layer 13 was further laminated thereon. Next, the laminate was pressurized at a pressure of about 190 MPa and pressure-bonded while being heated, thereby obtaining a pressure-bonded body as an assembly of pre-firing element bodies 10, which contained the pre-firing capacitive part 17.

### Preparation of Multilayer Ceramic Capacitor

The obtained pressure-bonded body was cut and singulated to obtain a pre-firing element body, and the element body was heated to 300° C. in a nitrogen atmosphere and subjected to a debinder treatment. The extraction surface of the element body after the debinder treatment, onto which the extraction pattern was extracted was immersed in the conductive paste containing nickel, thereby forming a precursor of the external electrode. Next, the element body after the debinder treatment, on which the precursor of the external electrode had been formed, was maintained at 800° C. for 30 minutes, fired at 1200° C. for 2 hours, maintained at 700° C. for 1 hour in a nitrogen atmosphere in the middle of a decrease in temperature, and cooled to around room temperature in a so-called reducing-water vapor atmosphere where water vapor was introduced to a reducing gas containing hydrogen in nitrogen, thereby obtaining a multilayer ceramic capacitor.

The obtained multilayer ceramic capacitor was formed such that the surface of the element body perpendicular to the lamination direction had a roughly rectangular parallelepiped shape with a size of 1.0 mm×0.5 mm and the dielectric layer had a thickness of 0.6 μm.

TABLE 1

| | | | | | Continuity | | Particle |
|---|---|---|---|---|---|---|---|
| | | | Electrode | Precipitate | rate of | Thickness | diameter of |
| | | | pattern | in internal | internal | of internal | dielectric |
| | Sub- | | forming | electrode | electrode | electrode | material |
| | element | Content (at %) | method | layer | layer (%) | layer (nm) | (nm) |
| Example 1 | Al/Fe/Si | 1.0/1.0/1.0/1.0 | Printing | Significant | 92 | 270 | 298 |
| Example 2 | Al/Fe/Si | 0.001/0.001/0.001 | Printing | Insignificant | 91 | 273 | 309 |
| Example 3 | Al/Fe/Si | 10/10/10 | Printing | Significant | 88 | 271 | 290 |
| Example 4 | Al/Fe/Si | 1.0/1.0/1.0 | Sputtering | Significant | 92 | 277 | 296 |
| Example 5 | Cr/Fe/Si | 1.0/1.0/1.0 | Printing | Significant | 88 | 280 | 299 |
| Example 6 | Cr/Fe/Si | 0.001/0.001/0.001 | Printing | Insignificant | 88 | 271 | 290 |
| Example 7 | Cr/Fe/Si | 10/10/10 | Printing | Significant | 87 | 274 | 309 |
| Example 8 | Cr/Fe/Si | 1.0/1.0/1.0 | Sputtering | Significant | 90 | 277 | 294 |
| Comparative | — | — | Printing | — | 57 | 410 | 396 |
| Example 1 | | | | | | | |
| Comparative | Al | 1.0 | Printing | Significant | 59 | 406 | 330 |
| Example 2 | | | | | | | |
| Comparative | Cr | 1.0 | Printing | Significant | 72 | 396 | 328 |
| Example 3 | | | | | | | |
| Comparative | Fe | 1.0 | Printing | Significant | 64 | 408 | 331 |
| Example 4 | | | | | | | |
| Comparative | Si | 1.0 | Printing | Significant | 58 | 390 | 331 |
| Example 5 | | | | | | | |
| Comparative | Al/Fe | 1.0/1.0 | Printing | Significant | 65 | 405 | 331 |
| Example 6 | | | | | | | |
| Comparative | Al/Si | 1.0/1.0 | Printing | Significant | 68 | 395 | 321 |
| Example 7 | | | | | | | |
| Comparative | Fe/Si | 1.0/1.0 | Printing | Significant | 58 | 404 | 338 |
| Example 8 | | | | | | | |
| Comparative | Cr/Fe | 1.0/1.0 | Printing | Significant | 67 | 403 | 333 |
| Example 9 | | | | | | | |
| Comparative | Cr/Si | 1.0/1.0 | Printing | Significant | 68 | 400 | 326 |
| Example 10 | | | | | | | |

### Examples 4 and 8

Multilayer ceramic capacitors were prepared in the same manner as in Example 1 except that an internal electrode pattern was formed by sputtering using individual targets of sub-elements and Ni listed in Table 1 and a dielectric green sheet on which the obtained internal electrode pattern and the extraction pattern had been formed was used.

### Comparative Example 1

A multilayer ceramic capacitor was obtained in the same manner as in Example 1 except that only Ni was used as the component of the internal electrode layer, and the internal electrode layer contained no sub-elements.

### Comparative Examples 2 to 10

Multilayer ceramic capacitors were obtained in the same manner as in Example 1 except that the type and the content of the sub-elements used were as listed in Table 1.

### Evaluation of Multilayer Ceramic Capacitor

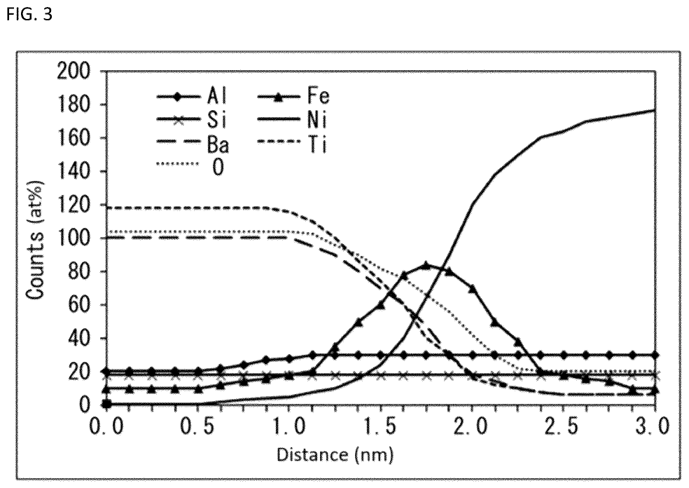

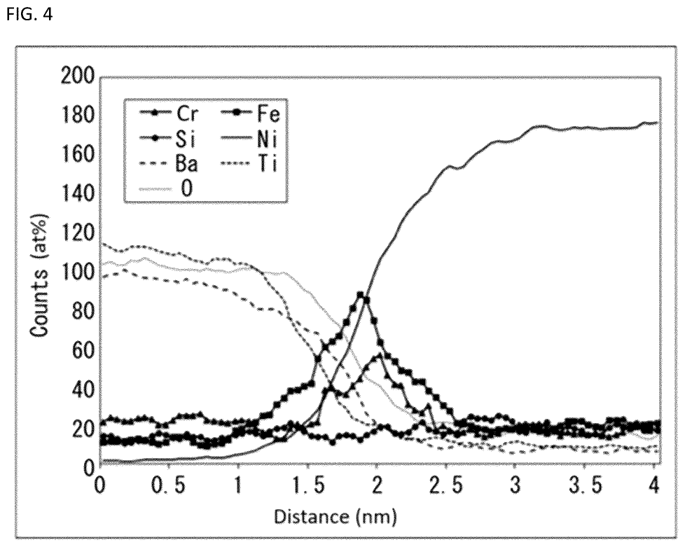

Elemental analysis of interface between dielectric layer and internal electrode layer Elemental analysis was performed on the interface between the dielectric layer and the internal electrode layer for each of the multilayer ceramic capacitors prepared in Examples 1 and 5. The analysis method was as described above. FIG. 3 shows a graph plotting the analysis results of the multilayer ceramic capacitor in Example 1, and FIG. 4 shows a graph plotting the analysis results of the multilayer ceramic capacitor in Example 5.

As shown in FIG. 3, in the multilayer ceramic capacitor of Example 1, since peaks of Fe were found between a distance of 1.0 nm to 2.0 nm, it was determined that Fe was segregated at the interface between the dielectric layer and the internal electrode layer.

As shown in FIG. 4, in the multilayer ceramic capacitor of Example 5, since peaks of Fe and Cr were found between a distance of 1.5 nm to 2.5 nm, it was determined that Fe and Cr were segregated at the interface between the dielectric layer and the internal electrode layer.

### Confirmation of Interface Between Dielectric Layer and Internal Electrode Layer and Dielectric Crystal Grain Boundary

The presence of interfaces between the dielectric layers and the internal electrode layers was confirmed for the multilayer ceramic capacitors prepared in Examples 1 and 5. TEM-EDS analysis was performed at five points for one sample, the complete view of particles in a visual field range of about 1 μm was confirmed, and the interfaces between the dielectric layers and the internal electrode layers and the dielectric crystal grain boundaries were confirmed at a high magnification in a visual field range of up to about 20 nm in the vicinity.

As a result, in the multilayer ceramic capacitor prepared in Example 1, it was confirmed that Fe was segregated at the interface between the dielectric layer and the internal electrode layer. Further, it was confirmed that Al, Fe, and Si were segregated at the dielectric crystal grain boundary. In addition, it was also confirmed that Ni serving as a main component of the internal electrode layer was precipitated at the dielectric crystal grain boundary.

Further, in the multilayer ceramic capacitor prepared in Example 5, it was confirmed that Cr and Fe were segregated at the interface between the dielectric layer and the internal electrode layer. Further, it was confirmed that Cr, Fe, and Si were segregated at the dielectric crystal grain boundary. In addition, it was also confirmed that Ni serving as a main component of the internal electrode layer was precipitated at the dielectric crystal grain boundary.

### Confirmation of Precipitate in Internal Electrode Layer

The presence of precipitates in the internal electrode layers was confirmed for the multilayer ceramic capacitors prepared in Examples 1 and 5. The confirmation was performed by the method described above.

In the multilayer ceramic capacitor prepared in Example 1, a plurality of segregated materials with a size of about several tens of nanometers were confirmed in the internal electrode layer. As a result of comparison with a composition map image, it was found that these segregated materials were Al—Si—O and Si—O. Further, another segregated material containing Fe was also confirmed.

In the multilayer ceramic capacitor prepared in Example 5, a plurality of segregated materials with a size of about several tens of nanometers were confirmed in the internal electrode layer. As a result of comparison with a composition map image, it was found that these segregated materials were Cr—Si—O and Si—O. Further, another segregated material containing Fe was also confirmed.

### Continuity Rate of Internal Electrode Layer

The multilayer ceramic capacitors prepared in Examples 1 to 8 and Comparative Examples 1 to 10 were respectively polished from the side surfaces to expose the internal electrode layers, and the internal electrode layers were observed at a magnification of 5000 to 10000 times using a microscope or the like. As shown in FIG. 2, a length L0 in the observed portion was measured using the scale or the like of the microscope, lengths L1 to L4 of the electrode portion of one internal electrode layer in a range of L0 were measured and summed, ΣLn/L0 was calculated to determine the continuity rate of the layer, this process was performed on 30 layers, and the average value thereof was obtained as the continuity rate. The results are listed in Table 1.

### Thickness of Internal Electrode Layer

The thickness of the internal electrode layer was measured for each of the multilayer ceramic capacitors prepared in Examples 1 to 8 and Comparative Examples 1 to 10. The measurement was performed on 30 measurement sites using a scanning electron microscope (SEM), and the average value thereof was obtained as the thickness. The results are listed in Table 1.

### Particle Diameter of Dielectric

The particle diameter of the dielectric was measured for each of the multilayer ceramic capacitors prepared in Examples 1 to 8 and Comparative Examples 1 to 10. The multilayer ceramic capacitor was cut in the lamination direction of the dielectric layers and the internal electrode layers, and the cross section thereof was observed using a scanning electron microscope (SEM). For the dielectric particles confirmed in the visual field, the maximum distance between two points positioned on the surface (contour) was measured, and the obtained value was divided by the observation magnification to obtain the particle diameter. The particle diameters of 200 or more dielectric particles were measured, and the average value of the obtained particle diameters was defined as the particle diameter of the dielectric. The results are listed in Table 1.

### Consideration

It was found that the multilayer ceramic capacitors of Examples 1 to 8 had internal electrode layers with a significantly large continuity rate as compared with the multilayer ceramic capacitors of Comparative Examples 1 to 10.

The multilayer ceramic capacitors of Examples 1 to 8 had internal electrode layers with a small thickness as compared with the multilayer ceramic capacitors of Comparative Examples 1 to 10. Since there was no difference in the thickness of the pre-firing internal electrode layer between the examples and the comparative examples, in the comparative examples, the internal electrode layer was fractured during the firing, the material present in the fractured part moved to a non-fractured part, and as a result, the thickness of the internal electrode layer was increased. Meanwhile, in the examples, it was assumed that the thickness of the internal electrode layer was decreased as a result of inhibiting the fracture of the internal electrode layer during the firing.

Further, it was found that in the multilayer ceramic capacitors of Examples 1 to 8, the particle diameter of the dielectric particles of the dielectric layer was small and the growth of the dielectric particles was inhibited as compared with the multilayer ceramic capacitors of Comparative Examples 1 to 10. This result suggests that the fracture of the internal electrode layer caused by the growth of the dielectric particles was inhibited.

Further, as a result of comparison between the multilayer ceramic capacitor containing three kinds of sub-elements of Example 1, the multilayer ceramic capacitor containing no sub-elements of Comparative Example 1, the multilayer ceramic capacitors containing one kind of sub-element of Comparative Examples 2 to 5, and the multilayer ceramic capacitors containing two kinds of sub-elements of Comparative Examples 6 to 10, it was found that since the multilayer ceramic capacitor of Example 1 contained three kinds of sub-elements, the continuity rate of the internal electrode layer was dramatically improved. This improvement was due to the interaction between the three kinds of metal elements.

Based on the results of the consideration described above, the following can be understood based on the contents of elements of Examples 1 to 8. The total content of Al or Cr is preferably 0.001 at % or greater and 10 at % or less with respect to the total amount of the main component metal element of the internal electrode layer 12, Al, Cr, Fe, and Si. Further, the content of Fe is preferably 0.001 at % or greater and 10 at % or less with respect to the total amount of the main component metal element of the internal electrode layer 12, Al, Cr, Fe, and Si. Further, the content of Si is preferably 0.001 at % or greater and 10 at % or less with respect to the total amount of the main component metal element of the internal electrode layer 12, Al, Cr, Fe, and Si.

According to the present invention, a ceramic electronic component such as a multilayer ceramic capacitor including an internal electrode layer with high continuity can be realized even when the thickness of the internal electrode layer is decreased. Such a ceramic electronic component has a large capacitance even in a case of having a small size, and thus can be suitably used in high-frequency communication systems such as mobile phones. Therefore, such ceramic electronic component is extremely useful industrially.

What is claimed:

1. A ceramic electronic component comprising:
an element body that includes a capacitive part which is a region where a plurality of dielectric layers containing a ceramic as a main component and a plurality of internal electrode layers are alternately laminated on each other,
wherein the capacitive part contains Al or Cr, and also Fe and Si, and
at least one selected from the group consisting of Al, Cr, Fe, and Si is precipitated in the internal electrode layers.

2. The ceramic electronic component according to claim 1,
wherein in a case where the capacitive part contains Cr, Fe and Cr are segregated at interfaces between the dielectric layers and the internal electrode layers, and Al or Cr, and also Fe and Si are segregated at dielectric crystal grain boundaries forming the dielectric layers.

3. The ceramic electronic component according to claim 1,
wherein a total content of Al or Cr in the capacitive part is 0.001 at % or greater and 10 at % or less with respect to a total amount of a main component metal element of the internal electrode layers, Al, Cr, Fe, and Si.

4. The ceramic electronic component according to claim 1,
wherein a content of Fe in the capacitive part is 0.001 at % or greater and 10 at % or less with respect to a total amount of a main component metal element of the internal electrode layers, Al, Cr, Fe, and Si.

5. The ceramic electronic component according to claim 1,
wherein a content of Si in the capacitive part is 0.001 at % or greater and 10 at % or less with respect to a total amount of a main component metal element of the internal electrode layers, Al, Cr, Fe, and Si.

6. The ceramic electronic component according to claim 1,
wherein the plurality of dielectric layers and the plurality of internal electrode layers each have a thickness of 1 μm or less.

7. The ceramic electronic component according to claim 1,
wherein the dielectric layers are formed of barium titanate.

8. The ceramic electronic component according to any one of claim 3,
wherein the main component metal element is Ni.

9. The ceramic electronic component according to any one of claim 4,
wherein the main component metal element is Ni.

10. The ceramic electronic component according to any one of claim 5,
wherein the main component metal element is Ni.

11. A method of manufacturing a ceramic electronic component, comprising:
forming an internal electrode pattern containing a main component metal element of an internal electrode layer, Al or Cr, Fe, and Si on a dielectric green sheet to form a lamination unit;
forming a plurality of the lamination units;
laminating the plurality of the lamination units to form a pre-firing capacitive part which is a region where the internal electrode pattern of each lamination unit are laminated on each other; and
firing the pre-firing capacitive part to form a capacitive part.

12. The method of manufacturing a ceramic electronic component according to claim 11,
wherein the forming of the internal electrode pattern is performed by a vacuum film formation process.

13. The method of manufacturing a ceramic electronic component according to claim 11,
wherein the forming of the internal electrode pattern is performed by printing.
